(19) United States
(12) Patent Application Publication
(10) Pub. No.: US 2025/0002772 A1
(43) Pub. Date: Jan. 2, 2025

(54) SCALE INHIBITOR COMPOSITION

(71) Applicants: Dow Global Technologies LLC, Midland, MI (US); Rohm and Haas Company, Collegeville, PA (US)

(72) Inventors: Puspendu Deo, Pearland, TX (US); Pramod Akhade, Houston, TX (US); Michael T. Petr, Trappe, PA (US); Dipti Singh, Sugar Land, TX (US); Graham P. Abramo, Penllyn, PA (US)

(21) Appl. No.: 18/688,370

(22) PCT Filed: Sep. 20, 2022
(86) PCT No.: PCT/US22/44112

§ 371 Date: Mar. 1, 2024

Related U.S. Application Data
(60) Provisional application No. 63/278,120, filed on Nov. 11, 2021.

(51) Int. Cl. C09K 8/528

(52) U.S. Cl. CPC C09K 8/528

(57) ABSTRACT

A scale inhibitor composition includes a reaction product of a polymerization mixture that includes acrylic acid. 2-acrylamido-2-methylpropane sulfonic acid, and a phosphoethyl methacrylate composition including at least 10 wt % of phosphoethyl methacrylate monoester, at least 10 wt % of phosphoethyl methacrylate diester, and at least 5 wt % of phosphoric acid, based on a total weight of the phosphoethyl methacrylate composition.

### FIELD

Embodiments relate to a scale inhibitor composition and methods of using such a scale inhibitor composition in processes such as oil and gas production.

### INTRODUCTION

A major flow assurance issue in oil and gas production (e.g., in oilfields) is mineral scale deposition. For example, during extraction of hydrocarbons from subterranean reservoirs, water is co-produced that usually includes dissolved metal ions, which can result in mineral scale precipitation and eventually deposition. Scales, which are typically hard adherent inorganic salts from aqueous solutions, can deposit on any surface leading to flow restriction within the subterranean reservoir and/or production lines, resulting in loss of hydrocarbon recovery and/or damage.

Common oilfield scales are carbonate (CaCO₃) and sulfate (BaSO₄/SrSO₄ and CaSO₄), which can precipitate from brine/water when there are changes in thermodynamic conditions or mixing of incompatible waters in the reservoir. A common technique for scale control is the addition of a low concentration of a scale inhibitor to process brine/water. Typically, these brines are very rich in multivalent cation ions such as calcium, magnesium, strontium, barium, and/or sodium. Brine with high level of dissolved multivalent ions, such as greater than 80,000 ppm, is considered as a high total dissolved solids (TDS) brine. For such TDS brine, while anionic scale inhibitors can interact with cations in the brine to minimize carbonate and sulfate scale formation, this interaction can lead to the precipitation of inhibitors as metal salts. These metal salts can cause undesirable plugging. For example, “pseudo scale” formation may occur at the tip of an injection nozzle due to incompatibility of a high concentration of the scale inhibitor in brine/water (such as local concentration effect).

To determine which scale inhibitor may be most effective for specific brines, brine compatibility screening is a common practice to evaluate various scale inhibitors at varying concentrations. Accordingly, new scale inhibitors are sought for use in such compatibility screening in an effort to improve scale inhibition in brine/water.

### SUMMARY

Embodiments may be realized by providing a scale inhibitor composition that includes a reaction product of a polymerization mixture that includes acrylic acid, 2-acrylamido-2-methylpropane sulfonic acid, and a phosphoethyl methacrylate composition including at least 10 wt % of phosphoethyl methacrylate monoester, at least 10 wt % of phosphoethyl methacrylate diester, and at least 5 wt % of phosphoric acid, based on a total weight of the phosphoethyl methacrylate composition.

### BRIEF DESCRIPTION OF THE DRAWINGS

Features of the embodiments will become more apparent to those of ordinary skill in the art by describing in detail exemplary embodiments thereof with reference to the attached drawings in which:

FIG. 1 illustrates the compatibility testing results for Working Example 1, in a brine solution with a high TDS content,

FIG. 2 illustrates the compatibility testing results for Comparative Example A, in a brine solution with a high TDS content,

FIG. 3 illustrates the compatibility testing results for Working Example 1, in a brine solution with a very high TDS content,

FIG. 4 illustrates the compatibility testing results for Comparative Example A, in a brine solution with a very high TDS content,

FIG. 5 illustrates the compatibility testing results for Comparative Example B, in a brine solution with a very high TDS content,

FIG. 6 illustrates the compatibility testing results for Comparative Example C, in a brine solution with a very high TDS content,

FIG. 7 illustrates the compatibility testing results for Comparative Example D, in a brine solution with a very high TDS content,

FIG. 8 illustrates the compatibility testing results for Comparative Example E, in a brine solution with a very high TDS content, and

FIG. 9 illustrates the dynamic scale loop results for Working Example 1, in a brine solution with a very high TDS content.

### DETAILED DESCRIPTION

Embodiments related to a scale inhibitor for use with brine/water such as in oil and gas product and/or other water processing. In exemplary embodiments, the scale inhibitor may be found through compatibility screening to be effective for brines that have a high and/or very high TDS content (such as greater than 80,000 ppm). The brine may be an oilfield brine.

The scale inhibitor according to embodiments includes a scale inhibitor composition that has a reaction product of a polymerization mixture including (e.g., consisting essentially of) acrylic acid, 2-acrylamido-2-methylpropane sulfonic acid, and a phosphoethyl methacrylate composition that includes at least 10 wt % of phosphoethyl methacrylate monoester, at least 10 wt % of phosphoethyl methacrylate diester, and at least 5 wt % of phosphoric acid, based on a total weight of the phosphoethyl methacrylate composition. The phosphoethyl methacrylate composition may further include at least 3 wt % of methyl methacrylate and at least 3 wt % methacrylic acid. The phosphoethyl methacrylate composition is different from a commercially available PEM, in view of the composition therewithin. The phosphoethyl methacrylate composition according to exemplary embodiments, when used to make a terpolymer based scale inhibitor composition, may result in a favorable scale inhibitor for improved compatibility screening in certain brines as compared to a commercially available PEM. Such certain brines may include brines with a total dissolved solids content of greater than 80,000 ppm and/or greater than 90,000 ppm.

With respect to the scale inhibitor composition, by acrylic acid it is meant a material including the following Formula 1 and isomers (e.g., stereoisomers) thereof:

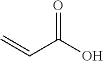

By 2-acrylamido-2-methylpropane sulfonic acid a material including the following Formula 2 and isomers (e.g., stereoisomers) thereof:

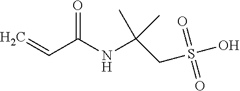

With respect to the phosphoethyl methacrylate composition, by phosphoethyl methacrylate monoester it is meant a material including the following Formula 3 and isomers (e.g., stereoisomers) thereof:

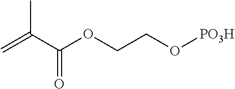

By phosphoethyl methacrylate diester it is meant a material including the following Formula 4 and isomers (e.g., stereoisomers) thereof:

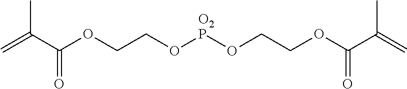

By methyl methacrylate it is meant a material including the following Formula 5 and isomers (e.g., stereoisomers) thereof:

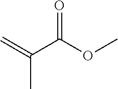

By methacrylic acid it is meant a material including the following Formula 6 and isomers (e.g., stereoisomers) thereof:

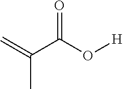

By phosphoric acid it is meant a material including the following Formula 7 and isomers (e.g., stereoisomers) thereof:

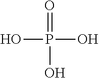

According to exemplary embodiments, the phosphoethyl methacrylate composition includes (e.g., consists essentially of) from 20 wt % to 70 wt % (e.g., 25 wt % to 65 wt %, 30 wt % to 50 wt %, 40 wt % to 45 wt %, etc.) of the phosphoethyl methacrylate monoester, from 10 wt % to 40 wt % (e.g., 10 wt % to 35 wt %, 15 wt % to 30 wt %, 15 wt % to 25 wt %, 18 wt % to 20 wt %, etc.) of the phosphoethyl methacrylate diester, from 5 wt % to 25 wt % (e.g., 10 wt % to 20 wt %, 12 wt % to 15 wt %, etc.) of methyl methacrylate, from 5 wt % to 25 wt % (e.g., 5 wt % to 15 wt %, 10 wt % to 15 wt %, etc.) of methacrylic acid, and from 5 wt % to 25 wt % (e.g., 10 wt % to 20 wt %, 15 wt % to 18 wt %, etc.) of phosphoric acid, based on the total weight of the phosphoethyl methacrylate composition. With the proviso that the total weight (of the actives) in the phosphoethyl methacrylate composition is 100%.

According to exemplary embodiments, the polymerization mixture includes (e.g., consists essentially of) from 30 wt % to 60 wt % (e.g., 35 wt % to 55 wt %, 41 wt % to 54 wt %, 45 wt % to 50 wt %, 46 wt % to 48 wt %, etc.) of the acrylic acid (based on total weight of actives and exclusive of any added water), from 30 wt % to 60 wt % (e.g., 35 wt % to 55 wt %, 40 wt % to 45 wt %, 42 wt % to 44 wt %, etc.) of the 2-acrylamido-2-methylpropane sulfonic acid based on total weight of actives and exclusive of any added water), and from 6 wt % to 19 wt % (e.g., 6 wt % to 15 wt %, 8 wt % to 12 wt %, 9 wt % to 11 wt %, etc.) of the phosphoethyl methacrylate composition based on total weight of actives and exclusive of any added water), based on the total weight of the polymerization mixture. With the proviso that the total weight (of the actives) in the polymerization mixture is 100%.

The scale inhibitor may include and/or consist essentially of the scale inhibitor composition. The scale inhibitor may further include water, such as from 10 wt % to 90 wt % (e.g., 25 wt % to 50 wt %, 35 wt % to 80 wt %, 45 wt % to 80 wt %, 55 wt % to 75 wt %, etc.) of water, based on a total weight of the scale inhibitor. The scale inhibitor composition may be combined with other scale inhibitors in a final end use. The scale inhibitor composition may be used in an oil and gas production process, e.g., may be added to brine/water used in oil and gas production. For example, the scale inhibitor composition may be added to a brine (e.g., oilfield brine) that has a total dissolved solids content of greater than 90,000 ppm (e.g., up to 550,000 ppm). The scale inhibitor composition may be continuously added to a stream of brine, e.g., added directly to the brine (such as production fluid that may include crude oil and brine). The scale inhibitor composition may be added in an effective amount, by which an amount that is effective as a scale inhibitor. The scale inhibitor composition may be introduced in an amount from 1 ppm to 1,000,000 ppm (e.g., 1 ppm to 500,000 ppm, 1 ppm to 100,000 ppm, 1 ppm to 50,000, etc.)

The scale inhibitor composition may be continuously injected into an oil and gas production equipment (such as a pipeline) or in stimulation fluids (such as hydraulic fracturing, matrix stimulation fluid, workover treatment like scale squeeze treatments, and re-fracturing) so as to control and/or prevent the deposition of scale within the equipment. The scale inhibitor composition may be added to a subterranean reservoir, such as a wellbore, for control of scale in such production processes.

### EXAMPLES

The following examples are provided to illustrate the embodiments of the invention but are not intended to limit the scope thereof. All parts and percentages are by weight unless otherwise indicated.

### Preparation of Scale Inhibitors

For preparing the scale inhibitor composition, the following materials are principally used:
AA Acrylic acid monomer (available from Sigma-Aldrich Corporation)
AMPS 2-acrylamido-2-methylpropane sulfonic acid monomer (available from Sigma-Aldrich Corporation)
Comparative PEM Phosphoethyl methacrylate monomer with concentrations of approximately 60 to less than 70 wt % of poly(oxy-1,2-ethanediyl), alpha-(2-methyl-1-oxo-2-propen-1-yl)-omega-(phosphonooxy); 15 to less than 20 wt % poly(oxy-1,2-ethanediyl), alpha, alpha-phosphinicobis [omega-[(2-methyl-1-oxo-2-propen-1-yl)oxy]; 3 to less than 5 wt % of phosphoric acid; 0.5 to less than 1 wt % of 1,4-dioxane; and 0.5 to less than 1 wt % of 4-methoxy phenol (available as SIPOMER PAM-100 from Solvay)
PEM Phosphoethyl methacrylate monomer solution that includes approximately 40-45 wt % of the phosphoethyl methacrylate mono ester, 18-20 wt % of the phosphoethyl methacrylate diester, 12-15 wt % of methyl methacrylate, 5-15 wt % of methacrylic acid, and 15-18 wt % of phosphoric acid (available from The Dow Chemical Company or affiliated company)

Referring to Table 1, the Scale Inhibitor Compositions of the Examples are prepared by polymerization of the compositions as follows (based on total actives):

TABLE 1

| Example | Component/Material | wt % |
|---|---|---|
| Working | AA | 47 |
| Example 1 | AMPS | 43 |
| | PEM | 10 |
| Comparative | AA | 47 |
| Example A | AMPS | 43 |
| | Comparative PEM | 10 |

The Scale Inhibitor Compositions are prepared as follows. A mixture of water (282.7 grams), sodium metabisulfite (3.9 grams), and iron sulfate heptahydrate (2.4 mg) are added to a 2 liter, 4 necked round bottom glass reactor fitted with a stirrer, a thermocouple, N2 inlet, and a reflux condenser. The contents of the reactor are heated to 80° C. under a nitrogen atmosphere with stirring. Then, a sodium metabisulfite solution (19.6 grams sodium metabisulfite dissolved in 30.6 grams of water) is fed to the reactor over 118 minutes. Three minutes after the start of the sodium metabisulfite feed, sodium persulfate solution (2.5 grams sodium persulfate dissolved in 30.6 grams of water) and the monomer mix containing water (17.8 grams), acrylic acid (154.7 grams), a 50 wt % solution of the sodium salt of 2-acrylamido-2-methyl-1-propane sulfonic acid in water (276 grams), and PEM or Comparative PEM (583.2 grams) are added concurrently to the reactor over 120 minutes. During feeds the reactor temperature is controlled at 72° C. A second charge of sodium persulfate solution (0.6 grams of sodium persulfate in 3.2 grams of water) is added to the reactor after the completion of monomer feeds and the reactor is held at 60° C. for 5 minutes. While maintaining the temperature at 60° C., 50% sodium hydroxide solution in water (41.5 grams) is added dropwise to the reactor over 15 minutes to partially neutralize the polymer. Then, the reactor is cooled to 50° C. and 30% hydrogen peroxide in water (2.2 grams) is added dropwise to the reactor. At 50° C. a second charge of 50% sodium hydroxide in water (36 grams) is added dropwise to the reactor over 15 minutes. Thereafter, water (56.6 grams) is added to afford a polymer solution that is 37% solids. The polymer solution is cooled to room temperature and collected to form the scale inhibitor.

Comparative Example B is prepared by mixing 0.985 grams of Comparative Example A with 0.015 grams of methyl methacrylate, for demonstration of a difference in performance between methyl methacrylate added post-polymerization of the scale inhibitor composition vs. added as part of PEM pre-polymerization of the scale inhibitor composition.

Comparative Example C is prepared by mixing 0.998 grams of Comparative Example A with 0.002 grams of methacrylic acid, for demonstration of a difference in performance between methacrylic acid added post-polymerization of the scale inhibitor composition vs. added as part of PEM pre-polymerization of the scale inhibitor composition.

Comparative Example D is prepared by mixing 0.983 grams of Comparative Example A with 0.017 grams of phosphoric acid, for demonstration of a difference in performance between phosphoric acid added post-polymerization of the scale inhibitor composition vs. added as part of PEM pre-polymerization of the scale inhibitor composition.

Comparative Example E is prepared by mixing 0.966 grams of Comparative Example A with 0.015 grams of methyl methacrylate, 0.002 grams of methacrylic acid, and 0.017 grams of phosphoric acid, for demonstration of a difference in performance such components being added together post polymerization of the scale inhibitor composition vs. added as part of PEM-pre-polymerization of the scale inhibitor composition.

### Compatibility Screening

Oil and gas production and other water services may use a compatibility screening process for qualifying scale inhibitors for their specific fields or applications. Prior to in-field performance testing, pre-selected scale inhibitors may go through a compatibility test with the brine system, such as a bottle testing process. The scale inhibitor may be tested at concentrations ranging from 0.1 wt % to 50 wt % in the brine solution. No further performance testing on the scale inhibitor may be done if the candidate scale inhibitor fails in the brine compatibility testing. Such failure may be demonstrated in photos by the appearance of precipitation and/or turbidity with the brine/water. In other words, if the resulting bottle test does not produce a substantially clear solution, the determination will be failure (i.e., incompatible). In contrast, if the bottle test does produce a substantially clear solution, the determination will be compatible per the bottle test.

The significance of the varying concentration relates to providing good results at varying locations including the injection nozzle tip where the local concentration of scale inhibitor may be extremely high vs downstream from adding where the scale inhibitor is further blended with the brine/water.

The Compatibility testing uses a high TDS brine (Brine 1-approximate TDS 94,077 ppm) and a very high TDS brine (Brine 2-approximate TDS 193,708 ppm), with a composition as shown in Table 2, below.

TABLE 2

| Dissolved Ion, ppm | Brine 1 | Brine 2 |
|---|---|---|
| Sodium (Na⁺) | 24980 | 45685 |
| Potassium (K⁺) | 361 | 0 |
| Calcium (Ca²⁺) | 8560 | 24349 |
| Magnesium (Mg²⁺) | 900 | 322 |
| Barium (Ba²⁺) | 225 | 2360 |
| Strontium (Sr²⁺) | 457 | 4590 |
| Chloride | 58060 | 116402 |
| Total dissolved solids, ppm | 94077 | 193708 |

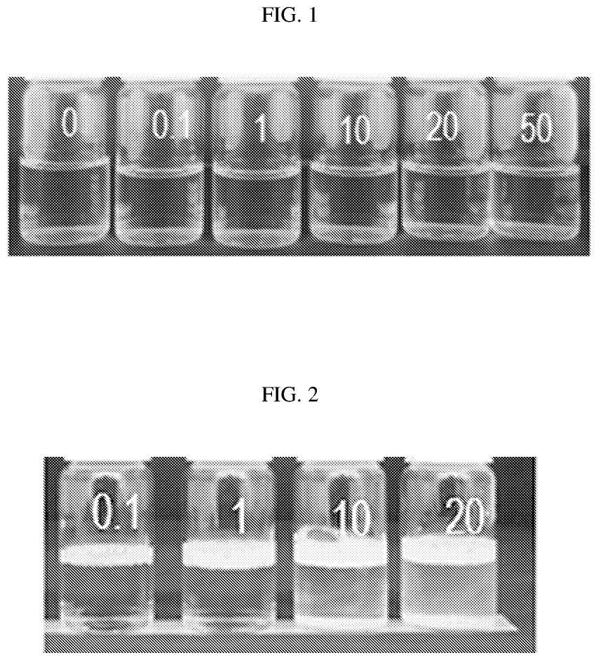

Prior to testing, the brine is filtered using a 0.45-micron filter to remove any foreign particles. The scale inhibitor (at 37% solids solution) examples are tested at varying concentrations of 0.1, 1, 10, 20 and 50 wt %, based on a total weight of the brine and scale inhibitor. In particular, each solution of brine and scale inhibitor are placed in a vial. The resultant mixture is then subjected to handshaking for 30 seconds and visual appearance thereafter is recorded. Referring to FIGS. 1-8, the visual observation is recorded as either incompatible or compatible.

Referring to FIGS. 1 and 2, it is shown for Brine 1, Working Example 1 is compatible at mixtures of each of 0.1, 1, 10, 20, and 50 wt %. In contrast, Comparative Example A shows turbidity and/or precipitation.

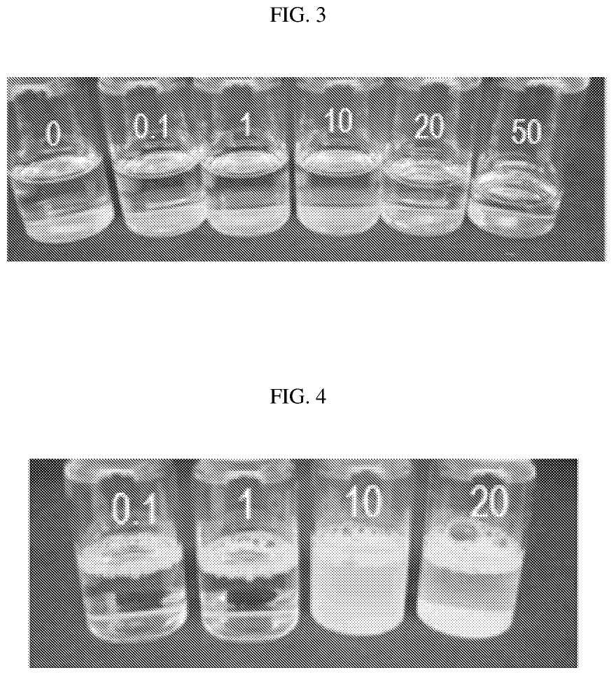

Referring to FIGS. 3 and 4, it is shown for Brine 2, similarly Working Example 1 is compatible at mixtures of each of 0.1, 1, 10, 20, and 50 wt %. In contrast, Comparative Example A shows turbidity and/or precipitation.

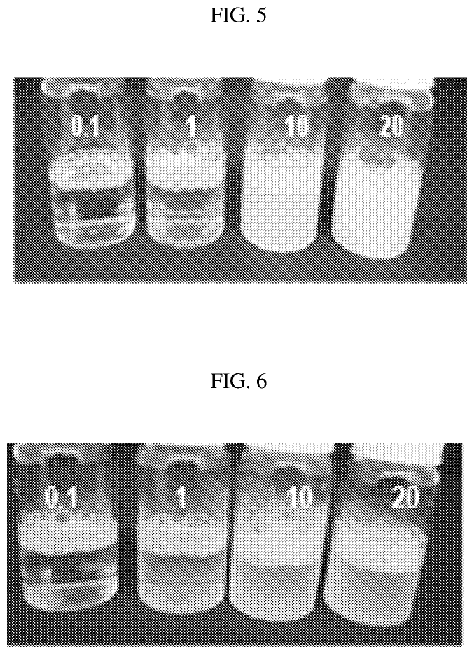

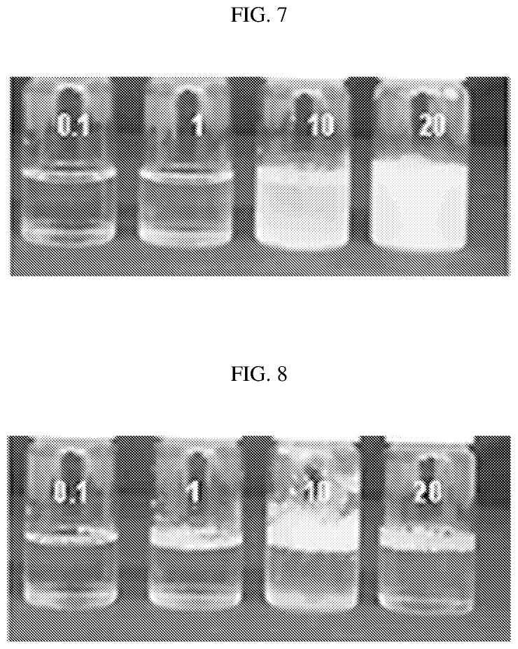

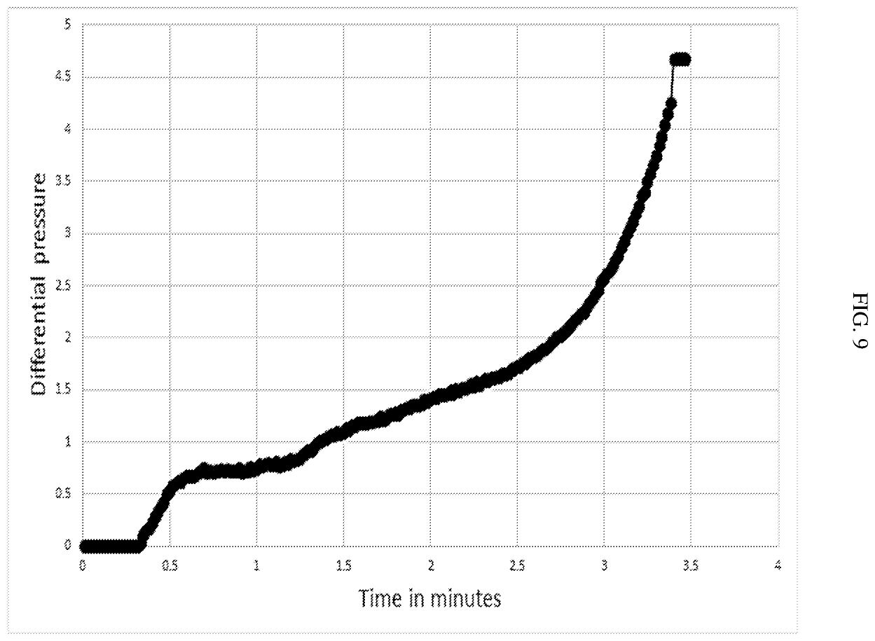

Referring to FIGS. 5, 6, 7, and 8, the scale inhibitor compositions are tested at 0.1, 1, 10, and 20 wt % (as determined based on total weight of the composition). Referring to FIG. 5, Comparative Example B shows turbidity and/or precipitation. Referring to FIG. 6, Comparative Example C shows turbidity and/or precipitation. Referring to FIG. 7, Comparative D shows turbidity and/or precipitation. Referring to FIG. 8, Comparative E shows turbidity and/or precipitation.

With Brine 2, further compatibility testing is done at a 10 wt % concentration with scale inhibitor having varying amounts of PEM. In particular, an example prepared using the same procedure as Working Example 1, except no PEM is added, and using a polymerization mixture including 40 wt % of AA and 60 wt % of AMPS, is found to be incompatible. Further, an example prepared using the same procedure as Working Example 1 and using a polymerization mixture that includes 55 wt % of AA, 40 wt % of AMPS, and 5 wt % of PEM, is found to be incompatible. Also, an example prepared using the same procedure as Working Example 1 and using a polymerization mixture that includes 47 wt % of AA, 33 wt % of AMPS, and 20 wt % of PEM, is found to be incompatible.

### Dynamic Loop Testing of Scale Inhibitor

A Dynamic Scale Loop (DSL) is a tube blocking system to examine the efficiency of scale inhibitors against the precipitation and deposition of scale and other salt crystals in a given brine system. The test simulates the field conditions where scale formation may occur on internal surfaces of pipelines, leading to an increase in differential pressure during the flow or transportation. The DSL test is an industry standard method, and it is used to evaluate the minimum inhibitory concentration (MIC) under dynamic conditions. There are three main steps involved in performing DSL operation: (i) Preparation of anion and cation brines, (ii) Control run with no inhibitor to calculate the blank time, and (iii) scale inhibitor run to evaluate the effectiveness and determine the optimal dosage of the product.

In a typical experiment, cation and anion brines are prepared separately. The brine solutions are then filtered through 0.45-micron filter paper prior to using them in DSL testing. Referring to FIG. 9, Brine 2 is used. For testing, the blank time is first determined by maintaining 5 ml/min of cation and anion brine through 1M differential coil. The blank time is the time required to observe an increase in differential pressure from 0 psi to 5 psi due to scale build up without the addition of scale inhibitor. The scale inhibitor performance is then evaluated by repeating the test at varied concentrations of scale inhibitor; for each dose rate, the test is to be allowed to proceed for 3× of the blank time. A “Pass” for a specific dose rate is given if the increase in differential pressure not reached 5 psi. The scale inhibitor dose is reduced, and the test is continued. The test is stopped when the differential pressure reaches 5 psi at times shorter than the required time to step down the scale inhibitor dose. The minimum inhibitory concentration (MIC) required to control scale is defined as the lowest dose rate at which the “Pass” criterion is met (i.e.: lowest scale inhibitor concentration that did not allow the differential pressure to reach 5 psi for a time equal or larger than 3× of the blank time). Referring to FIG. 9, DSL tests were conducted at 100° C. and 250 psi (system pressure).

While the foregoing is directed to exemplary embodiments, other and further embodiments may be devised without departing from the basic scope thereof, and the scope thereof is determined by the claims that follow.

1. A scale inhibitor composition comprising:
a reaction product of a polymerization mixture including:
acrylic acid,
2-acrylamido-2-methylpropane sulfonic acid, and
a phosphoethyl methacrylate composition that includes at least 10 wt % of phosphoethyl methacrylate monoester, at least 10 wt % of phosphoethyl methacrylate diester, and at least 5 wt % of phosphoric acid, based on a total weight of the phosphoethyl methacrylate composition.

2. The scale inhibitor composition as claimed in claim 1, wherein the phosphoethyl methacrylate composition further includes at least 3 wt % of methyl methacrylate and at least 3 wt % methacrylic acid.

3. The scale inhibitor composition as claimed in claim 1, wherein the phosphoethyl methacrylate composition includes from 20 wt % to 70 wt % of the phosphoethyl methacrylate monoester, from 10 wt % to 40 wt % of the phosphoethyl methacrylate diester, from 5 wt % to 25 wt % of the methyl methacrylate, from 5 wt % to 25 wt % of the methacrylic acid, and from 5 wt % to 25 wt % of the phosphoric acid, based on the total weight of the phosphoethyl methacrylate composition.

4. The scale inhibitor composition as claimed in claim 1, wherein the phosphoethyl methacrylate composition includes from 30 wt % to 50 wt % of the phosphoethyl methacrylate monoester, from 15 wt % to 30 wt % of the phosphoethyl methacrylate diester, from 10 wt % to 20 wt % of the methyl methacrylate, from 10 wt % to 20 wt % of the methacrylic acid, and from 10 wt % to 20 wt % of the phosphoric acid, based on the total weight of the phosphoethyl methacrylate composition.

5. The scale inhibitor composition as claimed in claim 1, wherein the polymerization mixture includes from 30 wt % to 60 wt % of the acrylic acid, from 30 wt % to 60 wt % of the 2-acrylamido-2-methylpropane sulfonic acid, and from 6 wt % to 19 wt % of the phosphoethyl methacrylate composition, based on a total weight of the polymerization mixture.

6. The scale inhibitor composition as claimed in claim 1, wherein the polymerization mixture includes from 45 wt % to 50 wt % of the acrylic acid, from 40 wt % to 45 wt % of the 2-acrylamido-2-methylpropane sulfonic acid, and from 8 wt % to 12 wt % of the phosphoethyl methacrylate composition, based on a total weight of the polymerization mixture.

7. A scale inhibitor for oil and gas production, the scale inhibitor including the scale inhibitor composition as claimed in any of claim 1.

8. A scale inhibition treatment method for oil and gas production, the method comprising introducing the scale inhibitor composition as claimed in claim 1 to brine or water.

9. The method as claimed in claim 8, wherein the scale inhibitor composition is introduced to brine having a total dissolved solids content of greater than 80,000 ppm.
